(19) United States
(12) Patent Application Publication
(10) Pub. No.: US 2006/0218151 A1
(43) Pub. Date: Sep. 28, 2006

(54) Use of a database storing domain names and business operational areas

(75) Inventors: Warren Adelman, Scottsdale, AZ (US); Michael Chadwick, Chandler, AZ (US)

Correspondence Address: GO DADDY GROUP, INC., 14455 NORTH HAYDEN ROAD, SUITE 219, SCOTTSDALE, AZ, 85260, US

(73) Assignee: The Go Daddy Group, Inc.

(21) Appl. No.: 11/090,397

(22) Filed: Mar. 25, 2005

(51) Int. Cl. G06F 17/30; G06F 15/16; G06F 7/00

(52) U.S. Cl. 707/10; 709/217

(57) ABSTRACT

A search engine website may receive a search term from a User, a relevant geographical location of the User and, from an on-line database such as a Domain Name System database, a WHOIS database or another database, a plurality of operational areas for a plurality of different businesses. Using the search term, the geographical location of the User and information regarding the operational areas of a plurality of businesses, combined with other information maintained by the search engine, a search result may be created and displayed for the User. In a preferred embodiment, descriptions and links to websites of businesses that have operational areas encompassing or proximate to the User's geographical location are displayed prominently in the search result.

### CROSS REFERENCE TO RELATED PATENT APPLICATIONS

This patent application is related to the following patent application concurrently filed herewith, all assigned to The Go Daddy Group, Inc.: U.S. PATENT APPLICATION SERIAL NO. ______, “CREATION OF A DATABASE STORING DOMAIN NAMES AND BUSINESS OPERATIONAL AREAS”.

### FIELD OF THE INVENTION

The present invention relates to systems and methods for creating, maintaining and using a database that stores domain names and related business operational areas. The domain names may be used to access websites of businesses, wherein the businesses may be associated with one or more business operational areas.

### BACKGROUND OF THE INVENTION

The Internet is a worldwide network of computers and computer networks arranged to allow the easy and robust exchange of information between Users of computers. Hundreds of millions of people around the world have access to computers connected to the Internet via Internet Service Providers (ISPs). Content providers place multimedia information, i.e. text, graphics, sounds, and other forms of data, at specific locations on the Internet referred to as websites. The combination of all the websites and their corresponding webpages on the Internet is generally known as the World Wide Web (WWW) or simply web.

Websites may be created using HyperText Markup Language (HTML). The HTML tags define how the webpages for the website are to be displayed. Users of the Internet may access content providers' websites using software known as a Web browser, such as MICROSOFT INTERNET EXPLORER or NETSCAPE NAVIGATOR. After the browser has located the desired webpage, it requests and receives information from the webpage, typically in the form of an HTML document, and then displays the webpage content for the User. The User may then view other webpages at the same website or move to an entirely different website using the browser.

Browsers are able to locate specific websites because each website, resource and computer on the Internet has a unique network address known as an Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other, e.g. 64.202.167.32. The notation is used to improve human readability. The newer IP address standard, often called IP Version 6 (IPv6) or Next Generation Internet Protocol (IPng), is a 128-bit binary number. The standard human readable notation for IPv6 addresses presents the network address as eight 16-bit hexadecimal words, each separated by a colon, for example 2EDC:BA98:0332:0000:CF8A:000C:2154:7313.

However, IP addresses, even in a human readable notation, are difficult to remember and use by people. Uniform Resource Locators (URL) are much easier to remember and may be used to point to any website, directory or file on the Internet. A browser is able to access a website on the Internet through the use of a URL. The URL may include a Hypertext Transfer Protocol (HTTP) request combined with the website's Internet address, also known as the website's domain name. An example of a URL with an HTTP request and domain name is: http://godaddy.com. In this example, the “http” identifies the URL as an HTTP request and the “godaddy.com” is the domain name.

Individuals, companies, and other entities that provide content on the web generally want to use their name or one of their trademarks as part of their domain name. Thus, domain names are generally company trademarks, personal names or short phrases concatenated with a top level domain name (TLD) extension (e.g. .com, .net, org, .us, .biz, etc.). Domain names created in this fashion are much easier to remember and use than their corresponding IP addresses.

The Internet Corporation for Assigned Names and Numbers (ICANN) is an internationally organized, nonprofit corporation that has responsibility for IP address space allocation, protocol identifier assignment, generic (gTLD) and country code (ccTLD) Top-Level Domain name system management, and root server system management functions. ICANN delegates the responsibility for maintaining an authoritative source of domain names and corresponding IP addresses to particular organizations (hereinafter Registries). The responsibility for managing each TLD is assigned to only one Registry.

For certain TLDs, e.g. .biz, .info, .name, and now .org, the Registry is also the authoritative source for contact information related to the domain name and is referred to as a “thick” registry. For other TLDs, e.g. .com, .net, only the domain name and name server information is stored within the Registry, and a Registrar is the authoritative source for the contact information related to the domain name. Such a Registry is referred to as a “thin” registry. Domain names may be organized through a central domain name Shared Registration System (SRS) based on their TLD.

The process for registering a domain name with a particular registry allows a Registrant, i.e. the person that registers and uses the domain name, to use an ICANN-accredited Registrar. For example if a Registrant, John Doe, wishes to register the domain name “JohnDoe.com”, John Doe may initially verify whether the desired domain name is or is not available by contacting a Registrar. The Registrant may make this contact using the Registrar's webpage and typing the desired domain name into a field on the Registrar's webpage created for this purpose. Upon receiving the request from the Registrant, the Registrar may ascertain whether “JohnDoe.com” has already been registered by checking the registry database associated with the TLD of the domain name. The results of the search may then be displayed on the webpage to thereby notify the Registrant of the availability of the domain name. If the domain name is available, the Registrant may proceed with the registration process. Otherwise, the Registrant may keep selecting alternative domain names until an available domain name is found.

The Domain Name System (DNS) is a distributed database that allows browsers, search engines and other Internet entities to determine an IP address for any of the domain names stored in the DNS. A Registrant may work through the registering Registrar to typically select two (although any number may be used) authoritative name servers for the Registrant's domain name. The authoritative name servers store the information necessary to find the name servers that store the IP address for the domain name. The Registrar may store the authoritative name servers for the domain name in the WHOIS database.

The Registry for the domain name may access the authoritative name servers, determine the name servers and store the name servers in the DNS root servers. The name servers may either provide the IP address of the domain name or provide the address to yet another name server. Occasionally, several levels of name servers may have to be searched before reaching a name server that has the IP address of the domain name.

The name servers for the domain name may be operated by the Registrant, the Registrar or a third party. The structure of the DNS database gives the Registrant or the Registrant's hosting provider a great deal of flexibility in assigning, controlling and updating the IP address for the domain name.

The Internet consists of millions of computers that store electronic files that may be accessed via a web browser. The Internet holds an enormous amount of data. Webpages are created to present all kinds of information, from commercial catalogs and advertisements, to scientific literature, to governmental regulations, etc. Without the appropriate tools, finding specific information stored somewhere on the Internet would be extremely difficult.

A search engine is a tool that facilitates locating desired information on a computer network such as the Internet. A User may access a website that hosts a search engine and the User may submit one or more search terms related to the information sought. Generally, a search engine is a computer program that, when queried for information, retrieves either related information or links to the location of related information, or both, by evaluating its database. In the Internet context, when a User submits a search term, the search engine usually responds with a search result. The search result generally includes a list of URLs pointing to information resources, typically webpages hosted on other websites that are derived from matching entries in the search engine's database. For convenience, the URLs are often presented as links, so that the User may simply click on the URL to access a website with the desired resources.

If electronic information or products that may be provided from anywhere in the world are being sought by a User via a search engine, there is no need to be concerned with the operational areas of the business that has the websites listed in the search results. However, if the User is searching for a business to supply a good or service that needs to be obtained locally (such as a pizza delivery service), it would be advantageous that only businesses with operating areas that cover the User's geographical location are included in the search results of the search engine.

In other situations, the specific location of the business, as opposed to a geographical area of operation, may be important. For example, hotels may accept customers' reservations from around the world, but the location of the hotel is the important factor for most customers.

Conventional methods may be used to determine a geographical location associated with an IP address or a geographical location of a hosting provider for a business. While these geographical locations may be the same as the operational areas of a business, the operational areas of a business may also be very different. In other words, the location of computer systems or a hosting provider for a business may not necessarily be the same as the operational areas of the business.

Thus, there is a need to be able to search the Internet via a search engine and have search results returned that include businesses with operational areas that encompass the geographical location of the User.

### SUMMARY OF THE INVENTION

The limitations cited above and others are substantially overcome through the systems and methods disclosed herein.

In one embodiment of the invention, a database may include a domain name and an operational area of a business associated with the domain name. Preferably, a network address (such as an IP address) associated with the domain name is also stored in the database.

In another embodiment, a Registrar's website may receive a domain name and an operational area of a business associated with the domain name from a Registrant. The Registrar's website may also receive or assign an authoritative name server for the domain name and store the domain name and the operational area in a database accessible over a global computer network and the authoritative name server in the WHOIS database. In another embodiment, the domain name, operational area and authoritative name server are stored in the WHOIS database. In another embodiment, the domain name, operational area and network address are stored in the DNS database. In yet another embodiment, the domain name and operational area are stored in a database accessible over a global computer network.

In another embodiment, a process for registering a domain name is provided. The registration process may include the steps of receiving a desired domain name from a Registrant, determining one or more operational areas of a business associated with the domain name and storing the domain name and the one or more operational area in a database accessible over a global computer network.

In another embodiment of the invention, a system is provided for displaying a list of links to websites based on a search term from a User. The system includes a database accessible over a global computer network and a search engine website capable of receiving a search term, accessing the database and providing to a User a list of links to websites. The database may include a domain name, a network address associated with the domain name for accessing a website of a business on a global computer network and an operational area associated with the business.

In another embodiment of the invention, a process is provided for a search engine to create a list of links to websites for a User. In this process the search engine receives a search term from a User, determines a User's geographical location, accesses a database to determine one or more operational areas for one or more businesses, creates a search result using the search term and the one or more operational areas, and displays the search result for the User. In this process the database may include one or more domain names, a network address associated with each domain name for accessing a website of a business on a global computer network and one or more operational areas of the business associated with the domain name.

It should be noted that the above described embodiments may be practiced without assigning every domain name in the database a network address or one or more operational areas.

The above features and advantages of the present invention will be better understood from the following detailed description taken in conjunction with the accompanying drawings.

### BRIEF DESCRIPTION OF THE DRAWINGS

FIG. 1 is a block diagram illustrating the relationships between a Domain Name Registrant, a Domain Name, a Website and a Business.

FIG. 2 is a block diagram illustrating the relationships between a Domain Name Registrant, a Global Computer Network, a Registrar and a Database.

FIG. 3 is a block diagram illustrating the structure of a database shown in FIGS. 1, 2 and 4.

FIG. 4 is a block diagram illustrating the relationships between Search Engine Users, a Global Computer Network, a Search Engine and a Database.

FIG. 5 is a flowchart illustrating a possible process embodiment of the invention.

FIG. 6 is a flowchart illustrating another possible process embodiment of the invention.

### DETAILED DESCRIPTION AND PREFERRED EMBODIMENT

The present invention will now be discussed in detail with regard to the attached drawing figures which were briefly described above. In the following description, numerous specific details are set forth illustrating the Applicant's best mode for practicing the invention and enabling one of ordinary skill in the art of making and using the invention. It will be obvious, however, to one skilled in the art that the present invention may be practiced without many of these specific details. In other instances, well-known machines and method steps have not been described in particular detail in order to avoid unnecessarily obscuring the present invention. Unless otherwise indicated, like parts and method steps are referred to with like reference numerals.

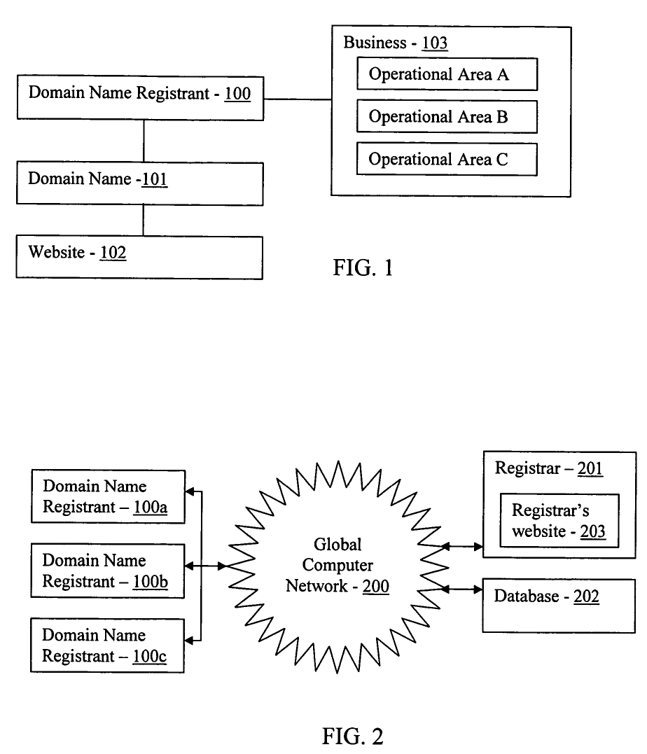

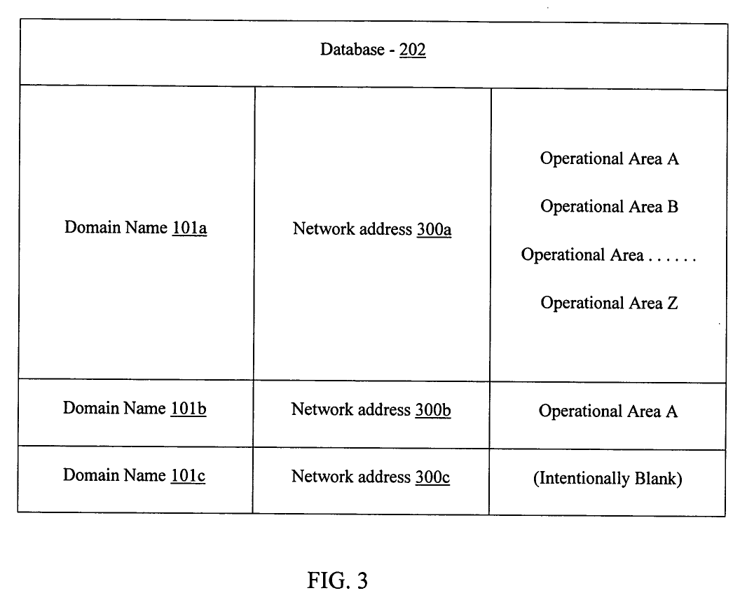

FIG. 1 is an exemplary block diagram illustrating the relationships between a domain name Registrant 100, a domain name 101, a website 102 and a business 103 having a plurality of operational areas A-C. FIG. 2 illustrates exemplary communication paths between a plurality of domain name Registrants 100a-c, a global computer network 200, a Registrar 201 having a Registrar website 203 and a database 202. FIG. 3 illustrates an exemplary structure of a database 202. The illustrated database 202 shows some possible relationships between a plurality of domain names 101a-c, a plurality of network addresses 300a-c and a plurality of operational areas.

FIGS. 1-3 illustrate possible embodiment of the invention, but many variations of the figures may be made and still fall within the scope of the invention as outlined in the claims. The Registrant 100 may be a natural person or a business entity. A domain name Registrant 100 may register a domain name 101 with a Registrar 201 (or a Reseller of domain names) over a global computer network 200 (such as the Internet) via a Registrar's website 203. While only three Registrants 100a-c are shown in FIG. 2, in practice any number of domain name registrants 100a-c may access the Registrar's website 203.

The domain name 101 may be assigned a network address 300a-c, such as an Internet Protocol (IP) address, and stored in a database 202, such as the Domain Name System (DNS). The network address permits browsers to access a Registrant's website 102 by accessing the network address associated with the Registrant's domain name 101 in the database 202. This embodiment of the database 202 permits a single database 202 to be accessed using a domain name 101 as a key to determine a network address 300 of a website 102 and the operational area(s), if any, of a business 103 associated with the domain name 101.

In another embodiment of the database 202, the network address 300a-c is not included in the database 202. In this embodiment, the DNS may be accessed to retrieve the IP address of a website 102 and the database 202 may be accessed to retrieve the operational area(s), if any, of a business 103 related to the domain name 101. This embodiment has the advantage of allowing independent control over the database 202 from the DNS at the expense of having to access two different databases to find the IP address and the operational area(s) for a business 103. In this embodiment, the database 202 may be the WHOIS database or any other database accessible over a global computer network.

The database 202 may also be the DNS database with the addition of stored operational areas, possibly in the text fields already provided in the DNS database. The structure and language used by the database 202 are not critical to the invention. The database 202 is preferably designed to be accessible over a global computer network 200, such as the Internet. Operational area(s) may be determined for any given business associated with a domain name stored in the database 202. The larger the number of domain names 101a-c and operational areas stored in the database 202, the more useful the database 202 becomes.

The Registrant's website 102 may be used to market and sell goods and services of a business 103. For purposes of this patent, a business may include, but is not limited to, a natural individual, a sole proprietorship, an association, an organization, a partnership as well as all other corporate structures. FIG. 1 illustrates an example where the Registrant 100 operates a business 103 that has three different operational areas A, B and C. The operational areas A, B and C represent geographical areas where the business is capable of operating, such as by providing goods and services to customers within a geographical area. Of course, other businesses may have any number of operational areas, even zero, and each operational area may have a different size, shape and location.

While preferred embodiments envision the operational areas as being a geographical areas or region, other embodiments may be practiced where the operational areas are specific locations. For example, the operational area of a business may be given and defined by a street address (for example, 14455 N. Hayden Road, Suite 219, Scottsdale, Ariz.) of the business 103. This approach limits the usefulness of the operational area A-C data since there is no way to determine the actual geographical region in which the business operates, however, a street address or location is much simpler to determine and store in the database 202. There are also situations where the location of a business 103 is more important than an area that the business 103 operates in. A hybrid system may also be used where operational areas A-C in the database may encompass both areas (for example a city if a business provides city-wide services) and location data (for example a street address where there is no attempt at defining a geographical region in which the business operates). A hybrid approach has the advantage of accommodating the needs of businesses that serve geographical regions and businesses where the location of the business is important.

The number of operational areas and their corresponding sizes for a business 103 depend on factors such as the particular size of the business 103, the distribution capabilities of the business 103, the ease of deliverability of the goods and services of the business 103 and the number and location of franchises or outlets of the business 103. Operational areas may be defined by a zip code, a city, a county, a state, a country, a world-wide indicator, a private indicator, a longitude/latitude coordinate, a SIC code, a street address or any other method of describing a geographical area or location.

Certain businesses 103 may be able to provide world-wide support, such as an electronic information delivery system. In such embodiments, the business 103 may be given a single operational area that is defined to be a world-wide indicator or marked in some other manner in the database 202 to indicate the domain name 101 for the website 102 has world-wide relevance.

In other embodiments, a business 103 may want to keep its website 102 private. For example the business 103 may have a website 102 containing company confidential information with access given to only a few employees or the business 103 may be an individual with a website 102 displaying family pictures with access given to just a few family members. In such cases, an operational area indicating the website is private, and should not be included in search results from a search engine, may be stored in the database 202. The lack of an operational area stored in the database 202 may be used to indicate either in a first embodiment that the website has a world-wide relevance or in a second embodiment that the website is private. The invention is not limited to any particular protocol in storing the data in the database 202. In addition, one or more site usage flags may be associated with a domain name and stored in the database 202 so that particular needs or requirements of different websites may be accounted for making the database 202 even more useful.

In certain embodiments, an operational area A-C may be assigned to be the geographical area of the hosting provider for the website 102, the geographical area associated with the IP address assigned to the domain name 101 or the geographical location of the contact information (Registrant, Administrative Contact or Technical Contact as examples) in the WHOIS database. These indirect methods are only “educated guesses” of an operational area A-C and occasionally work because businesses tend to use local hosting providers, the hosting providers use local IP addresses that are assigned to a geographical area and the contact information in the WHOIS database is often local addresses for the business. Thus, these indirect methods of determining an operational area of a business will sometimes produce correct results.

Using a hosting provider's geographical location, an IP address's geographical area or contact information in the WHOIS does have several problems. These methods will not provide information regarding the number of operational areas A-C or the size of the operational areas A-C of the business 103. Also, a business 103 may select a hosting provider located in an area different from the operational areas A-C of the business. For example, the hosting provider may be located near a corporate headquarters (or even an area totally unrelated to the business 103) and not in one of the operational areas A-C of the business. Likewise, the Registrant and contact information in the WHOIS database may not be geographical relevant for the business 103. For these reasons, it is preferred to only use the hosting provider's geographical location, the IP address's geographical area or the WHOIS geographical information to verify an operational area A-C found using another more reliable method or to determine an operational area A-C when no other more reliable data is readily available.

One method of determining the operational areas A-C for a business 103 is to receive the information when a domain name registrant 100a-c registers a domain name 101 with a Registrar 201 via a Registrar's website 203. A field, pull-down menu or other method specifically created for this purpose may be used by the Registrar's website 203 to receive the information from the domain name Registrant 100. The Registrant 100 is likely to be in the best position to know the number and sizes of the operational areas A-C of the business 103. The Registrar's website 203 may also be designed to allow the Registrant 100 the opportunity to periodically change the number and/or size of the operational area(s) as the business 103 changes over time. It is also highly desirable to allow the Registrant 100 to be able to change the authoritative name servers (performed at the Registrar 201) and IP address assigned to the domain name 101 as needed by the Registrant 100.

There will likely be a bias by domain name Registrants 100 to exaggerate or over-state the number and size of their operational areas A-C. The bias results from the fact that the larger the number and size of the operational areas A-C for a business, the more likely the Registrant's website 102 for the business will be listed in a search engine search result. The additional placements in search engine results will likely increase the traffic flow to the website 102 and increase the sales for the business 103. Thus, it is preferred that the operational areas A-C received from a Registrant 100 are verified. The verification process may include, but is not limited to, requesting supporting documents from the Registrant 100, reviewing on-line and off-line databases, reviewing the billing address of the Registrant 100 and/or reviewing the geographical location of the IP address used by Registrant 100. The verification process of the operational area(s) A-C of the business 103 may be as comprehensive or limited as desired.

Automated methods for determining operational areas A-C for a business 103 may also be used. For example, on-line databases may be searched to yield up-to-date information in a very timely manner, such as on-line business yellow-pages, on-line state corporation records or any other on-line databases that have information regarding businesses' operational areas. The number of on-line databases providing business-type information is rapidly growing, permitting a great wealth of relevant information to be found on the Internet.

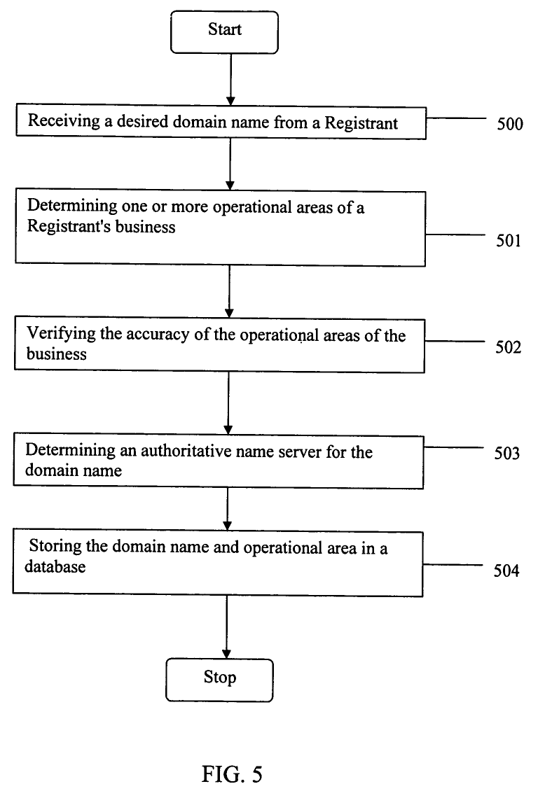

A sample process will now be described with reference to FIG. 5. A Registrar 201 (or Reseller of domain names) may receive a desired domain name 101 from a Registrant 100 at step 500. On-line registrations of domain names by Registrants 100 via a Registrar's website 203 are well known in the art and will not be described in great detail. The Registrar's website 203 may determine operational areas A-C of a business 103 associated with the desired domain name 101, typically by either requesting the information from the Registrant 100 or by searching one or more on-line databases at step 501. If the operational area(s) A-C are provided by the Registrant 100, it may be desirable for the Registrar's website 203 to verify the information at step 502. This may be done by requesting supporting documents from the Registrant 100 or accessing other resources.

The Registrar's website 203 may receive from the Registrant 100 authoritative name servers for the domain name during or at any time after the domain name registration process at step 503. The Registrar3 s website 203 may also assign default authoritative name servers to the domain name 101. The default authoritative name servers may be owned and operated by the Registrar for this purpose.

The Registrar's website 203 may store the domain name and operational area(s) A-C in a database 202 at step 504. The database 202 may be the DNS, WHOIS or some other globally accessible database. It should be made clear that the operational area(s) A-C may be received and saved in the database 202 during, or at any time after, the registration of the domain name 101. In addition, the Registrant 100 is preferably allowed to update the network address (such as an IP address) and the authoritative name servers as needed from time to time regardless of which database the network address and authoritative name servers are stored in.

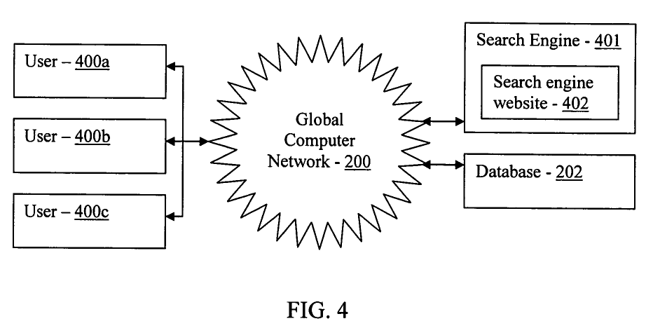

Once the database 202 has been created as described above by associating domain names 101 with corresponding operational area(s) A-C of businesses 103, any number of different applications may access the database 202 via a global computer network 200, such as the Internet. FIG. 4 illustrates a preferred use of the database 202 by a search engine 401 operating via its search engine website 402. Any number of search engine users 400a-c may access the search engine website 402 via the Internet 200.

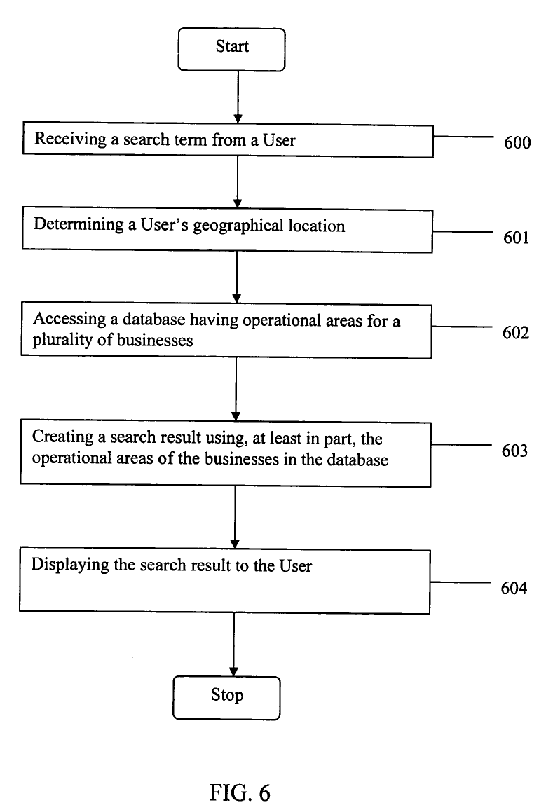

A flowchart illustrating a preferred process of using the invention is shown in FIG. 6. One of the search engine users 400a-c may enter a search term into the search engine website 402 in a field designed for this purpose at step 600. The search engine website 402 may determine a User's geographical location of the search engine user 400a-c by either requesting the relevant geographical location from the user 400a-c or through an automated means at step 601. The user may enter a zip code, city, state, county, country or other geographical information into the search engine website 402 to indicate the User's geographical location.

Automated means for determining a User's geographical location include, but are not limited to, determining a geographical area for the IP address used by the User, determining a geographical area for the Internet Service Provider of the User, reading a previously stored “cookie” with the information on the User's computer, recalling previous log-in data of the User that includes geographical information for the User or by accessing one or more on-line databases that include the geographical location of the User.

In certain situations, a User 400a-c may not want search results related to their current or normal geographical location. For example, a User 400a-c planning on taking a trip to a different city may desire search results from the search engine 401 related to this new city. Thus, it may be desirable to allow the User 400a-c to insert not only a search term (such as “hotel”) but also a relevant User's geographical location (such as Phoenix, Ariz.) in a field designed for this purpose, even though the User may be physically located in another town (such as Seattle, Wash.).

The search engine 401 may obtain domain names for businesses operating at the User's geographical location in step 602. The operating areas of the businesses may be found by searching in the DNS database, the WHOIS database or some other globally accessible database created for this purpose. In preferred embodiments, the DNS database, the WHOIS database or the globally accessible database is maintained such that a domain name may be used to find one or more operational areas of the business that owns the domain name.

The domain names and corresponding geographical areas may have already been read from the DNS database, the WHOIS database or some other database, organized and stored by the search engine in specialized internal databases to increase the speed of accessing this information. Using the entered search term, relevant User geographical location and the operational area(s) of businesses 103 (in combination with other information stored, maintained and organized by the search engine 401) the search engine may create a search result in step 603. The search engine 401 may compare the User's geographical location with the operational areas of different businesses to customize the results and make the search result more useful for the User.

In one possible embodiment, the search term may be used to determine which businesses' domain names to consider for the search results. After this first pass, the search result may be organized so that information and links to websites representing businesses that have operational areas that encompass the User's geographical location are placed in a prominent position in the search result. The search results may then be displayed to the User 400a-c at step 604. Other algorithms or methodologies may also be used to create the search result, but they preferably use the search term, the User's geographical location or relevant User's geographical location and the operational area(s) of one or more businesses as factors in creating a search result.

In a preferred embodiment, search results may be created and ordered by considering the User's geographical location within different businesses' operational area(s). For example, a first business having a first operational area with the User's geographical location located at or near the center of the first operational area may be displayed more prominently in a search result than a second business having a second operational area with the User's geographical location located at or near a fringe of the second operational area. Various other techniques may be used in comparing the User's geographical location with different businesses' operational areas to customize the search result for the User.

Some steps described above may be performed simultaneously or in different order. Also the various steps described above may be performed by various machines and apparatuses; and not necessarily by those described or mentioned above. Other embodiments and uses of this invention will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The elements described in this specification in plural form may also be construed as singular, unless specifically stated otherwise. The elements described in this specification in singular form may also be construed as plural, unless specifically stated otherwise.

The Abstract accompanying this specification is provided to enable the United States Patent and Trademark Office and the public generally to determine quickly from a cursory inspection the nature and gist of the technical disclosure and is in no way intended for defining, determining, or limiting the present invention or any of its embodiments.

We claim:

1. A system for providing a search result from a search engine, comprising:
a) a database accessible over a global computer network, comprising:
I) a domain name;
II) means for determining a network address for the domain name for accessing a website of a business on a global computer network; and
III) an operational area of the business associated with the domain name, and
b) a search engine website capable of receiving a search term, accessing the database and providing a search result to a User.

2. The system of claim 1, wherein the search result is created using the search term and the operational area of the business.

3. The system of claim 1, wherein the database further comprises:
IV) a plurality of operational areas of the business associated with the domain name.

4. The system of claim 1, wherein the database is a Domain Name System database.

5. The system of claim 1, wherein the database is a WHOIS database.

6. The database of claim 1, wherein the network address is an Internet Protocol address.

7. A process for a search engine to create a search result for a User, comprising the steps of:
a) receiving a search term from a User,
b) determining a relevant User's geographical location,
c) accessing a database, wherein the database comprises:
I) a domain name;
II) means for determining a network address for the domain name for accessing a website of a business on a global computer network; and
III) an operational area of the business associated with the domain name, and
d) creating a search result using the search term and the operational area, and
e) displaying the search result for the User.

8. The process of claim 7, wherein the relevant User's geographical location is determined by analyzing an Internet Protocol address of the User.

9. The process of claim 7, wherein the relevant User's geographical location is determined by asking for and receiving the relevant User's geographical location from the User.

10. The process of claim 7, wherein the relevant User's geographical location is read from a database that has been previously created to store a plurality of User's geographical locations for a plurality of Users.

11. The process of claim 7, wherein the relevant User's geographical location is read from data on the User's computer.

12. The process of claim 7, wherein the database is a Domain Name System database.

13. The process of claim 7, wherein the database is a WHOIS database.

14. The process of claim 7, wherein the means for determining a network address for a domain name comprises an authoritative name server.

15. The process of claim 7, wherein the means for determining a network address for a domain name comprises an Internet Protocol address.

16. A process for a search engine to create a search result for a User, comprising the steps of:
a) receiving a search term from a User,
b) receiving a geographical area from a User,
c) accessing a database, wherein the database comprises:
I) a plurality of domain names;
II) a plurality of means for determining a network address, wherein each network address is associated with a domain name for accessing a website of a business on a global computer network; and
III) a plurality of operational areas for a business, wherein one or more operational areas are associated with each domain name, and
d) creating a search result using the search term, the geographical area received from the User and one or more operational areas in the database, and
e) displaying the search result for the User.

17. The process of claim 16, wherein the geographical area received from the User is a zip code, a county, a city, a state or a country.

18. The process of claim 16, further comprising the step of: comparing the geographical area received from the User with one or more operational areas associated with at least one of the domain names prior to creating the search result.

19. The process of claim 18, wherein a website of a first business is only included in the search results if the geographical area received from the User is totally within at least one of the operational areas of the first business.

20. The process of claim 18, wherein a website of a first business is only included in the search results if the geographical area received from the User is at least partially within at least one of the operational areas of the first business.

21. The process of claim 18, wherein a website of a first business is only included in the search results if the geographical area received from the User is close to at least one of the operational areas of the first business.

22. The process of claim 16, wherein the geographical area received from the User is independent of an actual geographical location of the User.

23. The process of claim 16, wherein the database is a Domain Name System database.

24. The process of claim 16, wherein the database is a WHOIS database.

25. The process of claim 16, wherein the means for determining a network address for a domain name comprises an authoritative name server.

26. The process of claim 16, wherein the means for determining a network address for a domain name comprises an Internet Protocol address.
